(19) United States
(12) Patent Application Publication
(10) Pub. No.: US 2019/0304070 A1
(43) Pub. Date: Oct. 3, 2019

(54) IMAGE RECTIFICATION METHOD AND DEVICE, AND STORAGE MEDIUM

(71) Applicant: BOE TECHNOLOGY GROUP CO., LTD., Beijing (CN)

(72) Inventors: Yan Shen, Beijing (CN); Zhusong Yi, Beijing (CN); Minbiao Zhou, Beijing (CN)

(21) Appl. No.: 16/192,186

(22) Filed: Nov. 15, 2018

(30) Foreign Application Priority Data
Mar. 28, 2018 (CN) 201810265497.8

(51) Int. Cl. G06T 5/00; G09G 5/36

(52) U.S. Cl. CPC G06T 5/006; G09G 5/36

(57) ABSTRACT

The present disclosure provides an image rectification method and device and a non-transitory computer-readable storage medium. The method includes obtaining an image to be displayed and a display region of a display screen. The method includes determining a to-be-rectified region of the image to be displayed according to the image to be displayed and the display region. The method includes rectifying the to-be-rectified region of the image to be displayed to make the rectified image to be displayed match the display region.

### CROSS REFERENCE

This application is based upon and claims priority to Chinese Patent Application No. 201810265497.8, filed on Mar. 28, 2018, the entire contents thereof are incorporated herein by reference.

### TECHNICAL FIELD

The present disclosure relates to display control technologies, and in particular, to an image rectification method and device, and a display device.

### BACKGROUND

At present, display interfaces of many display device screens are rectangular, and images obtained by cameras are all rectangular images as shown in FIG. 1(a). Smart rear-mirror screens are usually irregularly shaped screens as shown in FIG. 1(b), and when the irregularly shaped screens show rectangular images, the display effect is as shown in FIG. 1(c). That is, when the irregularly shaped screens display a rectangular image, the extra portion of the rectangular image is simply removed, resulting in that the rectangular image cannot be displayed normally, which affects users' viewing experience.

### SUMMARY

The present disclosure provides an image rectification method and device and a non-transitory computer-readable storage medium.

According to a first aspect of the arrangements of the present disclosure, there is provided an image rectification method. The method includes obtaining an image to be displayed and a display region of a display screen. The method includes determining a to-be-rectified region of the image to be displayed according to the image to be displayed and the display region. The method includes rectifying the to-be-rectified region of the image to be displayed to make the rectified image to be displayed match the display region.

According to an exemplary arrangement, determining the to-be-rectified region of the image to be displayed according to the image to be displayed and the display region includes: obtaining a shape parameter of the display region and a shape parameter of the image to be displayed; and obtaining the to-be-rectified region by using an image rectification algorithm based on the shape parameter of the display region and the shape parameter of the image to be displayed.

According to an exemplary arrangement, determining the to-be-rectified region of the image to be displayed according to the image to be displayed and the display region includes obtaining a shape parameter of the display region and a shape parameter of the image to be displayed. Further, such a block includes determining an overlap region of the display region and the image to be displayed according to the shape parameters, and determining the to-be-rectified region of the image to be displayed according to a positional relationship of the overlap region, the image to be displayed, and the display region.

According to an exemplary arrangement, determining the to-be-rectified region of the image to be displayed according to a positional relationship of the overlap region, the image to be displayed, and the display region includes if the overlap region overlaps the image to be displayed, determining that a region corresponding to the image to be displayed is the to-be-rectified region. If the overlap region overlaps the display region, such a block include determining a region of the image to be displayed that is outside the overlap region as the to-be-rectified region. If the overlap region is a part of both the display region and the image to be displayed, the block includes determining that a region corresponding to the image to be displayed is the to-be-rectified region.

According to an exemplary arrangement, rectifying the to-be-rectified region of the image to be displayed to make the rectified image to be displayed match the display region includes determining an image rectification algorithm according to the display region. Such a block includes obtaining a source shape parameter and a target shape parameter of the to-be-rectified region. The block includes based on the source shape parameter and the target shape parameter, rectifying the to-be-rectified region by using the image rectification algorithm to make the rectified image to be displayed match the display region.

According to an exemplary arrangement, determining the to-be-rectified region of the image to be displayed includes obtaining a trigger operation of a user, and determining the to-be-rectified region according to the trigger operation.

According to a second aspect of arrangements of the present disclosure, there is provided an image rectification device. The image rectification device includes a display region obtaining module configured to obtain an image to be displayed and a display region of a display screen. The image rectification device includes a to-be-rectified region determining module configured to determine a to-be-rectified region of the image to be displayed according to the image to be displayed and the display region. The image rectification device includes a to-be-rectified region rectifying module configured to rectify the to-be-rectified region of the image to be displayed to make the rectified image to be displayed match the display region.

According to an exemplary arrangement, the to-be-rectified region determining module further includes a first shape parameter obtaining unit configured to obtain a shape parameter of the display region and a shape parameter of the image to be displayed. The to-be-rectified region determining module further includes a to-be-rectified region obtaining unit configured to obtain the to-be-rectified region by using an image rectification algorithm based on the shape parameter of the display region and the shape parameter of the image to be displayed.

According to an exemplary arrangement, the to-be-rectified region determining module further includes a second shape parameter obtaining unit configured to obtain a shape parameter of the display region and a shape parameter of the image to be displayed. The to-be-rectified region determining module further includes an overlap region determining unit configured to determine an overlap region of the display region and the image to be displayed according to the shape parameters. The to-be-rectified region determining module further includes a second to-be-rectified region obtaining unit configured to determine the to-be-rectified region of the image to be displayed according to a positional relationship of the overlap region, the image to be displayed, and the display region.

According to an exemplary arrangement, the second to-be-rectified region obtaining unit further includes a first determining unit configured to, if the overlap region overlaps the image to be displayed, determine that a region corresponding to the image to be displayed is the to-be-rectified region. The second to-be-rectified region obtaining unit further includes a second determining unit configured to, if the overlap region overlaps the display region, determine a region of the image to be displayed that is outside the overlap region as the to-be-rectified region. The second to-be-rectified region obtaining unit further includes a third determining unit configured to, if the overlap region is a part of both the display region and the image to be displayed, determine that a region corresponding to the image to be displayed is the to-be-rectified region.

According to an exemplary arrangement, the to-be-rectified region rectifying module further includes a rectification algorithm determining unit configured to determine an image rectification algorithm according to the display region. The to-be-rectified region rectifying module further includes a third shape parameter obtaining unit configured to obtain a source shape parameter and a target shape parameter of the to-be-rectified region. The to-be-rectified region rectifying module further includes a to-be-rectified region rectifying unit configured to, based on the source shape parameter and the target shape parameter, rectify the to-be-rectified region by using the image rectification algorithm to make the rectified image to be displayed match the display region.

According to an exemplary arrangement, the display region obtaining module further includes a trigger operation obtaining unit configured to obtain a trigger operation of a user. The display region obtaining module further includes a to-be-rectified region determining unit configured to determine the to-be-rectified region according to the trigger operation.

According to a third aspect of arrangements of the present disclosure, there is provided an image rectification device. The image rectification device includes a processor, and a memory configured to store instructions and files which are executable by the processor. The processor is configured to execute executable instructions in the memory to implement the operations of the method according to the first aspect.

According to another aspect of arrangements of the present disclosure, there is provided a non-transitory computer-readable storage medium having stored therein instructions that, when executed by a processor of a display device, causes the display device to perform the above image rectification method.

According to the above arrangements, in the present disclosure, by adjusting or rectifying the image to be displayed to make the rectified image meet the requirements of the display region in the display screen, the present disclosure can avoid the situation in related arts that the display screen only displays a part of the image content to be displayed, and thus the viewing experience of users can be improved by completely displaying images.

It should be understood that the above general description and the following detailed description are merely exemplary and explanatory and are not limiting of the present disclosure.

### BRIEF DESCRIPTION OF THE DRAWINGS

The drawings herein are incorporated into the description and form a part of the specification, showing the arrangements of the present disclosure and explaining the principle together with the description.

FIG. 1(a) to FIG. 1(c) are schematic diagrams showing the effect of displaying a rectangular image on a irregularly shaped screen in related arts;

FIG. 2 is a schematic flow chart of an image rectification method according to an arrangement of the present disclosure;

FIG. 3 is a schematic flow chart of an image rectification method according to an arrangement of the present disclosure;

FIG. 4 is a schematic diagram showing an overlap relationship of an image to be displayed and a display region according to an arrangement of the present disclosure;

FIG. 5 is a schematic diagram of an application scenario according to an arrangement of the present disclosure;

FIG. 6 is a schematic diagram of a multi-buffering mechanism according to an arrangement of the present disclosure;

FIG. 7 is a block diagram showing a system structure including a packaged image rectification method module according to an arrangement of the present disclosure;

FIG. 8 shows a display effect of the system of FIG. 7;

FIGS. 9 to 13 are block diagrams of an image rectification device according to an arrangement of the present disclosure; and

FIG. 14 is a block diagram of an image rectification device according to an arrangement of the present disclosure.

### DETAILED DESCRIPTION

Exemplary arrangements will be described in detail herein, examples of which are illustrated in the drawings. When the following description refers to the drawings, the same numbers in different drawings indicate the same or similar elements, unless otherwise indicated. The arrangements described in the following exemplary arrangements do not represent all arrangements consistent with the present disclosure. Instead, they are merely examples of devices and methods consistent with aspects of the present disclosure as detailed in the appended claims.

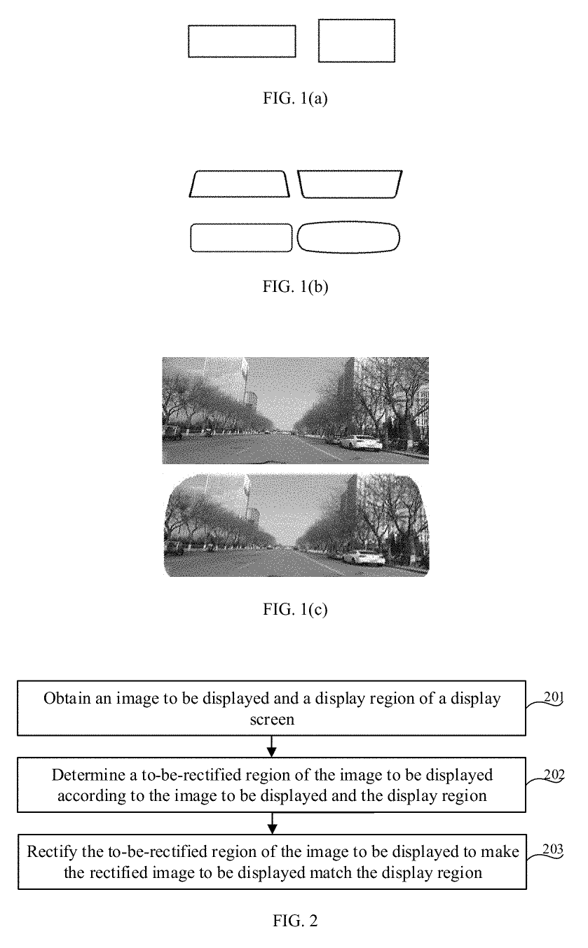

At present, display interfaces of many display device screens are rectangular, and images obtained by cameras are all rectangular images as shown in FIG. 1(a). Smart rear-mirror screens are usually irregularly shaped screens as shown in FIG. 1(b). When the irregularly shaped screen show a supposedly rectangular image (the upper half of FIG. 1(c)), the display effect is as shown in the lower half of FIG. 1(c). That is, when the irregularly shaped screens display a rectangular image, the extra portion of the rectangular image is simply removed, resulting in that the rectangular image cannot be displayed normally, which affects users' viewing experience. To solve the above problem, an arrangement of the present disclosure provides an image rectification method, and FIG. 2 is a flow chart of an image rectification method according to an arrangement of the present disclosure. For example, the image rectification method in the arrangement of the present disclosure is executed by a processor. Referring to FIG. 2, an image rectification method includes the following blocks.

In 201, an image to be displayed and a display region of a display screen are obtained.

In an arrangement, the image to be displayed may be obtained from an image capture device, such as a camera or a webcam, and the camera may send the image to be displayed directly to the processor. In another arrangement, the image to be displayed may also be read from a storage device. For example, a camera collects images (which may be video frames) and the collected images are stored in the storage device. The processor reads the image(s) from the storage device as the image(s) to be displayed. In still another arrangement, the image to be displayed may be input by a user.

In an arrangement, the processor and a display screen are connected through a communication interface, and the processor can request a display region of the display screen through the communication interface of the display screen, for example, a width and a height of the display region, a parameter of a irregularly shaped region. The whole or a part of the display region displays images. In another arrangement, the display region data of the display screen can be saved in the storage device in advance, and this can reduce the number of the communications between the processor and other external devices and increase the process speed.

It can be understood that the order of obtaining the image to be displayed and obtaining the display region of the display screen is not limited, and those skilled in this art can set the order according to actual application scenarios.

In 202, a to-be-rectified region of the image to be displayed is determined according to the image to be displayed and the display region.

In the present arrangement, the determining of the to-be-rectified region according to the image to be displayed and the display region may include the following scheme:

In a first scheme, the to-be-rectified region is determined by using the big data method. First, a large number of display region samples of the display screens (the number can be set according to actual scenarios) are obtained, a large number of samples of the image to be displayed are obtained, and then a rectification region model is trained by using the sample data to train to obtain the trained rectification region model. After obtaining the image to be displayed and the display region, the image to be displayed and the display region are input to the trained rectification region model so as to obtain the to-be-rectified region. The rectification model may be a circular region, an elliptical region, or a polygonal region. For example, the polygonal region may be a trapezoidal region or an inverted trapezoidal region, a diamond shaped region, or the like.

In a second scheme, the image to be displayed and the display region are compared to determine the to-be-rectified region. In the same coordinate system, the image to be displayed and the display region are compared, and then the to-be-rectified region is determined according to the relationship between the positions or areas of the image to be displayed and the display region, which will be described in detail in subsequent arrangements.

In a third scheme, a user may select the to-be-rectified region. In the present arrangement, the processor obtains a trigger operation of the user, and then the to-be-rectified region is determined according to the position coordinates corresponding to the trigger operation. For example, in an edit mode, the user selects a plurality of positions from the image to be displayed, and the region surrounded by the plurality of positions forms the to-be-rectified region. As another example, in the edit mode, the user selects at least one diagonal line of the to-be-rectified region by using a gesture, and the to-be-rectified region is determined according to at least one diagonal line.

In the present arrangement, several ways of determining the to-be-rectified region are introduced. Those skilled in this art can select a proper way to determine the to-be-rectified region, depending on actual application scenarios. Corresponding solutions also fall within the protection scope of the present disclosure.

In 203, the to-be-rectified region of the image to be displayed is rectified to make the rectified image to be displayed match the display region.

In the present arrangement, after obtaining the to-be-rectified region, the processor determines an image rectification algorithm according to the display region, and then obtains a source shape parameter and a target shape parameter of the to-be-rectified region. By inputting the source shape parameter and the target shape parameter into the image rectification algorithm, the rectified image to be displayed can be obtained. In this way, the image to be displayed matches the display region of the display.

It can be understood that the image rectification algorithm may be implemented by an image rectification algorithm in related arts, such as a contour-based image rectification algorithm, an image geometric distortion rectification algorithm, an image segmentation transformation rectification algorithm, or an artificial neural network image recognition rectification algorithm or the like. Taking the contour-based image rectification algorithm as an example, a processor performs graying and threshold-binarization on the image to be rectified, and then detects the contour of the image. Next, the processor searches the enclosing matrix and the angle of the contour, and performs rotation rectification according to the angle. Finally, the processor extracts the contour and cuts out an image from the image to be rectified after the rotation, and then rectifies the image. The skilled person can select an appropriate image rectification algorithm according to a specific scenario, and all such selection of image rectification algorithm also falls within the protection scope of the present disclosure.

In an arrangement, the pixels of the image to be displayed are stretched and shifted according to a setting rule, so that all the pixels of the image to be displayed are located within the overlap region, so that the display region completely displays all the pixels, that is, completely displays the image to be displayed.

In another arrangement, the image to be displayed includes a plurality of application APPs, at least one APP is located outside the overlap region, and the processor may adjust the position coordinates of the at least one APP to a range corresponding to the overlap regions, thus the display region completely displays the APP.

In still another arrangement, a processor may further divide the image to be displayed into a plurality of parts, and then adjust each part according to an adjustment manner of the APP or the pixel point, so that the display screen can display a part of the image to be displayed one time. When a user triggers the display, such as sliding upward, sliding downward, pulling left or pulling right, the processor adjusts the next part of the image to be displayed. Or, the processor processes all parts of the image to be displayed, and then the display screen displays individual parts in turn.

It can be seen that, in the present arrangement, the image to be displayed is rectified based on the display region of the display screen to make the rectified image meet the requirement of the display region. The arrangement can avoid the situation in related arts that the display screen only displays a part of the image to be displayed. In the present arrangement, the display screen can completely display the image to be displayed, which can improve the viewing experience of users.

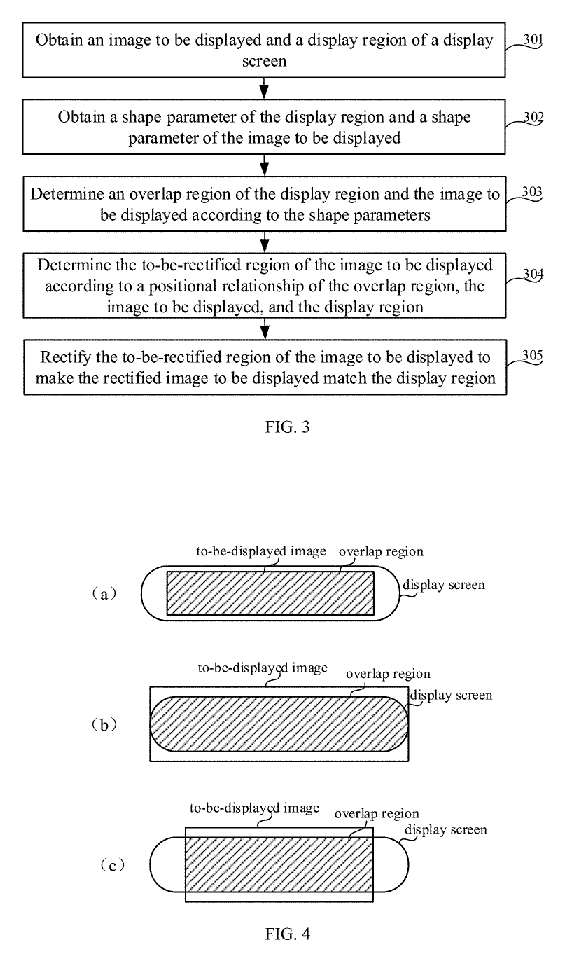

An arrangement of the present disclosure further provides an image rectification method, and FIG. 3 is a schematic flow chart of an image rectification method according to an arrangement of the present disclosure. For convenience of description, the image rectification method in the arrangement of the present disclosure is executed by a processor. Referring to FIG. 3, an image rectification method includes the following blocks.

In 301, an image to be displayed and a display region of a display screen are obtained.

The specific implementations and principles of blocks 301 and 201 are the same. Details regarding block 301 can be found in the above descriptions regarding block 201, and repeated descriptions are omitted here.

In 302, a shape parameter of the display region and a shape parameter of the image to be displayed are obtained.

In the present arrangement, the processor selects the shape parameters from the image to be displayed. The shape parameters may include height, width, resolution of the image to be displayed and coordinate data of each pixel. Of course, coordinate data of each pixel may also be obtained, and then the height and width of the image to be displayed are calculated. Those skilled in this art can select the shape parameters of the image to be displayed according to actual application scenarios.

In the present arrangement, the processor selects the shape parameters from the display region data of the display screen. The shape parameters may include the height, width, and resolution of the display region and coordinate data of each pixel. Of course, the coordinate data of each pixel may also be obtained, and then the height and width of the display region are calculated.

In 303, an overlap region of the display region and the image to be displayed is determined according to the shape parameters.

In the present arrangement, the processor places the shape parameter of the display region and the shape parameter of the image to be displayed in the same coordinate system, and then compares the image to be displayed with the display region to obtain an overlap region of the image to be displayed and the display region. Exemplary operations are described as follows:

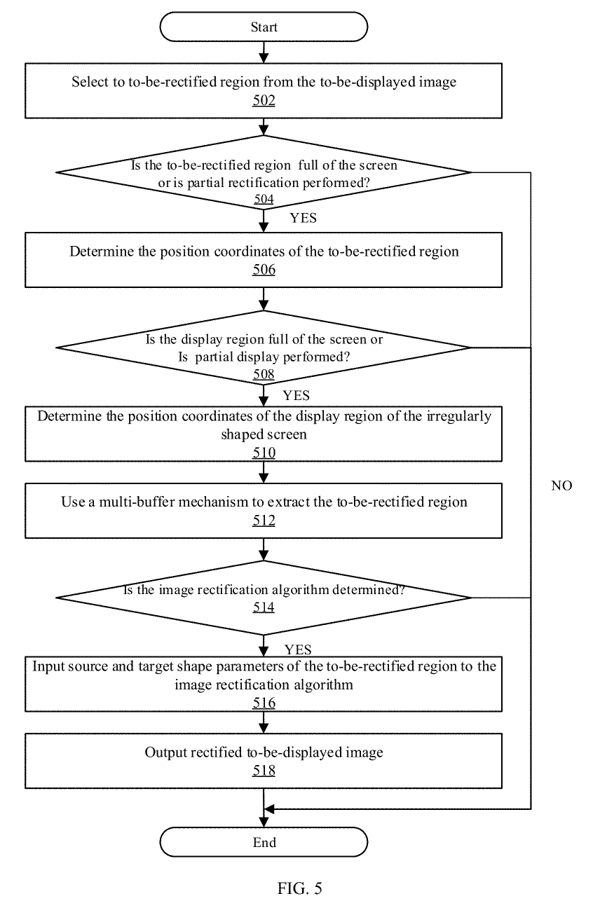

In Scene 1, referring to FIG. 4(a), the overlap region coincides with the image to be displayed.

In Scene 2, referring to FIG. 4(b), the overlap region coincides with the display region.

In Scene 3, referring to FIG. 4(c), the overlap region is a part of both the display region and the image to be displayed.

In 304, the to-be-rectified region of the image to be displayed is determined according to a positional relationship of the overlap region, the image to be displayed, and the display region.

In the present arrangement, the processor determines the to-be-rectified region of the image to be displayed according to the positional relationship among the overlap region, the image to be displayed, and the display region.

In an arrangement, if the overlap region overlaps the image to be displayed, it is indicated that the area of the image to be displayed is smaller than or equal to the area of the display region, and the entire image to be displayed may be taken as the to-be-rectified region. Since the area of the image to be displayed is smaller than or equal to the area of the display region, the display region can completely display the entire image to be displayed, and the processor may not process the image to be displayed, that is, there is no to-be-rectified region in the scene.

In another arrangement, if the overlap region overlaps the display region, a region outside the overlap region in the image to be displayed is determined as the to-be-rectified region.

In still another arrangement, if the overlap region is a part of both the display region and the image to be displayed, it is determined that the region of the image to be displayed outside the overlap region is the to-be-rectified region. In this scenario, the processor appropriately adjusts the image to be displayed, so that the region outside the overlap region is integrated into the overlap region, and the display region completely displays the entire image to be displayed.

In 305, the to-be-rectified region of the image to be displayed is rectified to make the rectified image match the display region.

The specific implementations and principles of blocks 305 and 203 are the same. Details of block 305 can be found in the above descriptions regarding block 203, and repeated descriptions are omitted here.

It can be seen that, in the arrangement, the display region and the image to be displayed are compared, the to-be-rectified region of the image to be displayed is determined according to the overlap image, and the to-be-rectified region is rectified. In this way, the image to be displayed matches the display region. Thus, the present disclosure can avoid the situation in related arts that the display screen only displays a part of the image to be displayed. In the present arrangement, the display screen can completely display the image to be displayed, which can improve the viewing experience of users.

FIG. 5 is a schematic diagram of an application scenario according to an arrangement of the present disclosure. In the present arrangement, an image rectification method provided by an arrangement of the present disclosure is described in detail by taking an Android system application interface and an irregularly shaped display screen as an example.

Referring to FIG. 5, in the present arrangement, an image to be displayed and an application interface region of the irregularly shaped screen are determined in advance, and a to-be-rectified region is selected from the image to be displayed (502). Then, to determine whether the to-be-rectified region is full of the screen or partially rectification is performed (504), and if yes, the position coordinates of the to-be-rectified region are determined (506); otherwise the image rectification process is ended.

Referring still to FIG. 5, in the present arrangement, it is determined in advance whether the irregularly shaped screen can completely or partially display the rectified image to be displayed (508), and if yes, the position coordinates of the display region of the irregularly shaped screen can be determined (510); otherwise the image rectification process is ended.

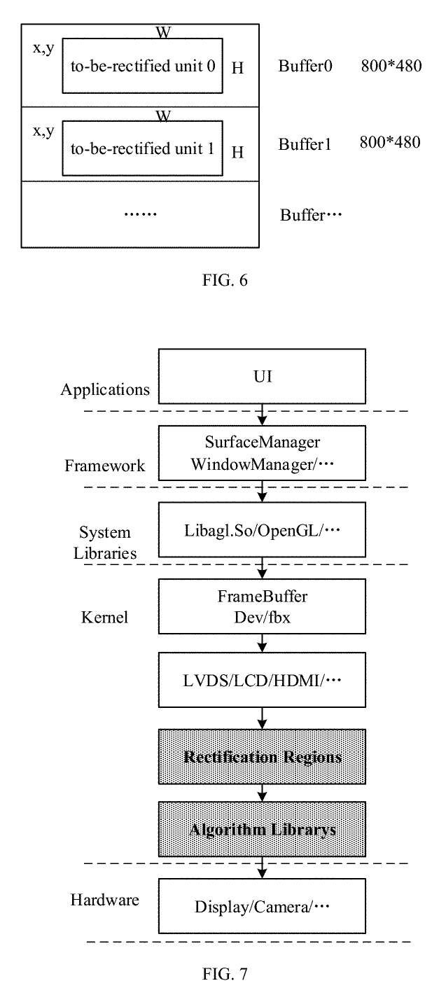

In the present arrangement, a multi-buffer mechanism is used to buffer the image to be displayed and the application interface region of the shaped screen (512), referring to the buffer result shown in FIG. 6. The processor may extract corresponding to-be-rectified unit(s) according to the position coordinates of the to-be-rectified region. Referring still to FIG. 6, the Famebuffer of the Android system corresponds to a plurality of buffer spaces Buffer, and the Buffer space size may be 800*480 pixels. Framebuffer->base is the base address of the Buffer space, and the base addresses of other Buffer spaces and the image to be displayed can be calculated by the base address and the offset address. In the present arrangement, an image storage content of 800*480 or less can be obtained from any Buffer space, thus extracting a valid to-be-rectified region from a plurality of Buffer spaces, such as Buffer0, Buffer1, . . . and so on. In this way, it can be ensured that the existing images can be displayed normally after rectification.

For example, if the to-be-rectified region includes a to-be-rectified unit 0 and a to-be-rectified unit 1, the extraction manner may include the following operations.

The to-be-rectified unit 0 can be obtained by:

For(i=0;i<h;i++)

For(j=0;j<w;j++){

Char*GetRchar=Framebuffer->base+(800*(y+i)+x+j)*4;

Char*GetGchar=Framebuffer->base+(800*(y+i)+x+j)*4+1;

Char*GetBchar=Framebuffer->base+(800*(y+i)+x+j)*4+2;

Char*GetAchar=Framebuffer->base+(800*(y+i)+x+j)*4+3; }

The to-be-rectified unit 1 can be obtained by:

For(i=0;i<h;i++)

For(j=0;j<w;j++){

Char*GetRchar=Framebuffer->base+offset1+(800*(y+i)+x+j)*4;

Char*GetGchar=Framebuffer->base+offset1+(800*(y+i)+x+j)*4+1;

Char*GetBchar=Framebuffer->base+offset1+(800*(y+i)+x+j)*4+2;

Char*GetAchar=Framebuffer->base+offset1+(800*(y+i)+x+j)*4+3; }.

It should be noted that, in the present arrangement, the shape parameters (that is, source shape parameters) of the to-be-rectified region may include an abscissa x, an ordinate y, a width w, and a height h, where 0=<x<=800, 0=<y<=480, 0<w<800, and 0<h<480.

Thereafter, whether or not the image rectification algorithm can be determined is judged based on the to-be-rectified region. In the present arrangement, an image rectification algorithm is provided in the form of a C/C++ library. The C/C++ library may include a plurality of image rectification function implementations required for the to-be-rectified region. In an arrangement, the delay of each image rectification algorithm needs to be less than 10 ms to ensure that the display system does not run very slowly or becomes choppy. It can be understood that the image rectification algorithm in the present arrangement is closely related to the display region of the irregularly shaped screen, that is, the shape parameters of the display region (the target shape parameters of the to-be-rectified region) can be obtained after the image rectification algorithm is determined.

Referring again to FIG. 5, if the image rectification algorithm is determined at 514, the source shape parameters and the target shape parameters of the to-be-rectified region are input to the image rectification algorithm (516), and the rectified image to be displayed is obtained and the rectified image to be displayed is output to the irregularly shaped screen (518). If the image rectification algorithm is not determined at 514, the image rectification process is ended.

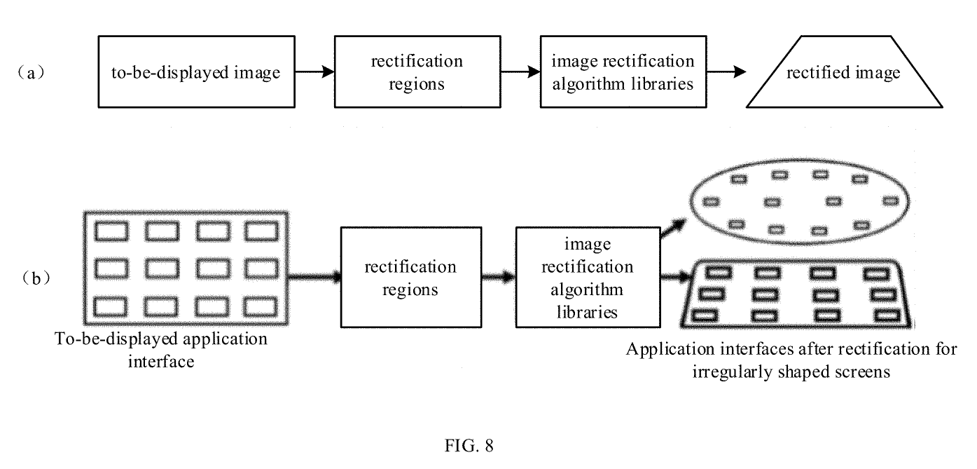

In order to facilitate the transplantation of the image rectification method provided by the present disclosure, in an arrangement, the program corresponding to the image rectification method is packaged to form image rectification algorithm libraries and rectification modules in the Android system. FIG. 7 is a structural block diagram of a system including a packaged image rectification method according to an arrangement of the present disclosure. Referring to FIG. 7, in the present arrangement, the rectification algorithm libraries (Algorithm Library) and the to-be-rectified region extracting module (Rectification Regions) are disposed between a hardware layer (display screen, camera, etc.) and an image call interface (LVDS, LCD, HDMI, etc.) in the kernel, so that a display interface of an application layer can be transmitted to the to-be-rectified region (Rectification Regions) and the image rectification algorithm libraries through an architecture layer (SurfaceManager/WindowManager/ . . . ), the system libraries, the FarmeBuffer in the kernel, and the image call interface. Two modules provided in the present arrangement rectifies the display interface image, and sends the rectified image to the display screen to display, and the display effect is as shown in FIG. 8(a) and FIG. 8(b). Referring to FIG. 8(a), when the image to be displayed is an image, the image to be displayed is sequentially input to the to-be-rectified extracting module and the image rectification algorithm libraries which performs translation, stretching, etc. on the image, so as to make the rectified image to be displayed match the irregularly shaped screen. Referring to FIG. 8(b), when the image to be displayed is an application interface, the application interface is sequentially input to the to-be-rectified extracting module and the image rectification algorithm libraries, and the APPs in the application interface are rearranged, so that the APPs can be displayed on the irregularly shaped screen. In the present arrangement, the image to be displayed matches the irregularly shaped screen, so that the irregularly shaped screen completely displays all or part of the image to be displayed, and the occurrence of removing a part of the image to be displayed is avoided.

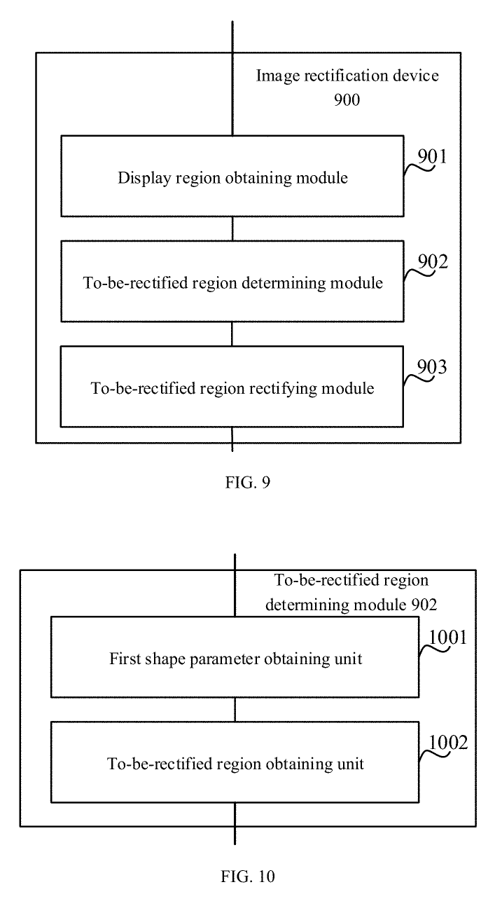

FIG. 9 is a block diagram of an image rectification device according to an arrangement of the present disclosure. Referring to FIG. 9, an image rectification device 900 includes a display region obtaining module 901, a to-be-rectified region determining module 902, and a to-be-rectified region rectifying module 903.

The display region obtaining module 901 is configured to obtain an image to be displayed and a display region of a display screen.

The to-be-rectified region determining module 902 is configured to determine a to-be-rectified region of the image to be displayed according to the image to be displayed and the display region.

The to-be-rectified region rectifying module 903 is configured to rectify the to-be-rectified region of the image to be displayed to make the rectified image to be displayed match the display region.

In an arrangement of the present disclosure, referring to FIG. 10, on the basis of the image rectification device shown in FIG. 9, the to-be-rectified region determining module 902 includes a first shape parameter obtaining unit 1001 and a to-be-rectified region obtaining unit 1002.

The first shape parameter obtaining unit 1001 is configured to obtain a shape parameter of the display region and a shape parameter of the image to be displayed.

The to-be-rectified region obtaining unit 1002 is configured to obtain the to-be-rectified region by using an image rectification algorithm based on the shape parameter of the display region and the shape parameter of the image to be displayed.

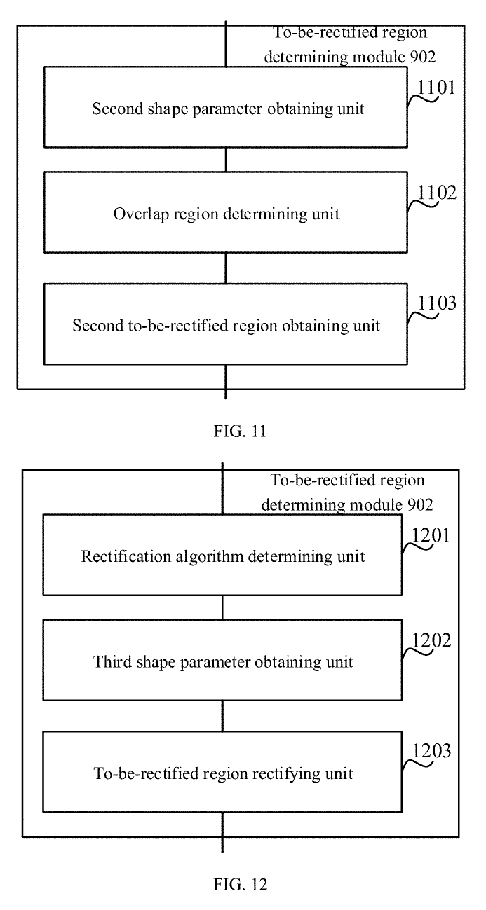

In an arrangement of the present disclosure, referring to FIG. 11, on the basis of the image rectification device shown in FIG. 9, the to-be-rectified region determining module 902 includes a second shape parameter obtaining unit 1101, an overlap region determining unit 1102, and a second to-be-rectified region obtaining unit 1103.

The second shape parameter obtaining unit 1101 is configured to obtain a shape parameter of the display region and a shape parameter of the image to be displayed.

The overlap region determining unit 1102 is configured to determine an overlap region of the display region and the image to be displayed according to the shape parameters.

The second to-be-rectified region obtaining unit 1103 is configured to determine the to-be-rectified region of the image to be displayed according to a positional relationship of the overlap region, the image to be displayed, and the display region.

In an arrangement of the present disclosure, the second to-be-rectified region obtaining unit 1103 includes a first determining unit, a second determining unit or a third determining unit.

The first determining unit is configured to, if the overlap region overlaps the image to be displayed, determine that a region corresponding to the image to be displayed is the to-be-rectified region.

The second determining unit is configured to, if the overlap region overlaps the display region, determine a region of the image to be displayed that is outside the overlap region as the to-be-rectified region.

The third determining unit is configured to, if the overlap region is a part of both the display region and the image to be displayed, determine that a region corresponding to the image to be displayed is the to-be-rectified region.

In an arrangement of the present disclosure, referring to FIG. 12, on the basis of the image rectification device shown in FIG. 9, the to-be-rectified region rectifying module 903 includes a rectification algorithm determining unit 1201, a third shape parameter obtaining unit 1202, and a to-be-rectified region rectifying unit 1203.

The rectification algorithm determining unit 1201 is configured to determine an image rectification algorithm according to the display region.

The third shape parameter obtaining unit 1202 is configured to obtain a source shape parameter and a target shape parameter of the to-be-rectified region.

The to-be-rectified region rectifying unit 1203 is configured to, based on the source shape parameter and the target shape parameter, rectify the to-be-rectified region by using the image rectification algorithm to make the rectified image to be displayed match the display region.

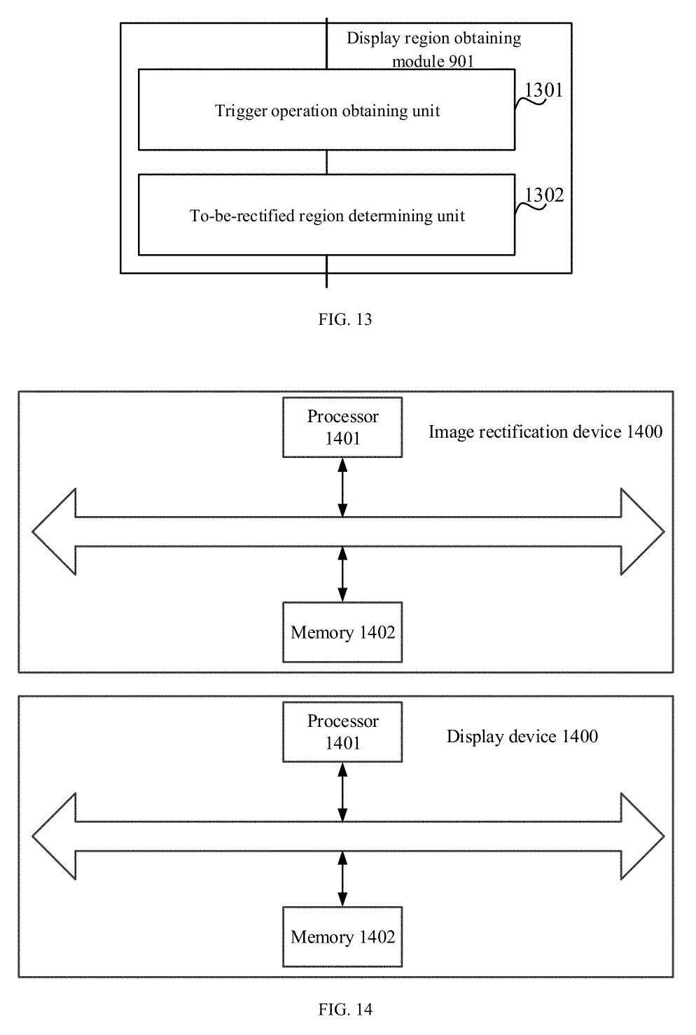

In an arrangement of the present disclosure, referring to FIG. 13, on the basis of the image rectification device shown in FIG. 9, the display region obtaining module 901 includes a trigger operation obtaining unit 1301 and a to-be-rectified region determining unit 1302.

The trigger operation obtaining unit 1301 is configured to obtain a trigger operation of a user.

The to-be-rectified region determining unit 1302 is configured to determine the to-be-rectified region according to the trigger operation.

It is to be understood that the image rectification device provided by the arrangement of the present disclosure corresponds to the image rectification method, and details regarding the device can be found in the description regarding the method arrangements and repeated descriptions are omitted here.

FIG. 14 is a block diagram of an image rectification device according to an arrangement of the present disclosure. Referring to FIG. 14, a display device 1400 includes a processor 1401 and a memory 1402.

The memory 1402 is configured to store instructions and files which are executable by the processor 1401.

The processor 1401 is configured to execute executable instructions in the memory 1402 to implement the blocks of the image rectification method shown in FIGS. 2 to 8. Details can be found in the above description regarding the method arrangements and repeated descriptions are omitted here.

In an exemplary arrangement, there is also provided a display device which includes the image rectification device as described.

In exemplary arrangements, there is also provided a non-transitory computer-readable storage medium including instructions, such as included in the memory 1402, executable by the processor 1401 in the device 1400, for performing the above-described methods. For example, the non-transitory computer-readable storage medium may be a ROM, a RAM, a CD-ROM, a magnetic tape, a floppy disc, an optical data storage device, and the like.

In the present disclosure, the terms “first” and “second” are used for descriptive purposes only and are not to be construed as indicating or implying relative importance. The term “plurality” refers to two or more, unless specifically defined otherwise.

Other arrangements of the present disclosure will be readily apparent to those skilled in the art upon consideration of the specification and practice of the disclosure herein. The present application is intended to cover any variations, uses, or adaptations of the present disclosure, which are in accordance with the general principles of the present disclosure and include common general knowledge or conventional technical means in the art that are not disclosed in the present disclosure. The specification and arrangements are to be only considered as illustrative, the truth scope and spirit of the present disclosure are defined by appended claims.

It is to be understood that the present disclosure is not limited to the precise structures shown and described in the drawings, and various modifications and changes can be made without departing from the scope of the present disclosure. The scope of the present disclosure is limited only by the appended claims.

What is claimed is:

1. An image rectification method, comprising:
obtaining an image to be displayed and a display region of a display screen;
determining a to-be-rectified region of the image to be displayed according to the image to be displayed and the display region; and
rectifying the to-be-rectified region of the image to be displayed to make the rectified image to be displayed match the display region.

2. The image rectification method according to claim 1, wherein determining the to-be-rectified region of the image to be displayed according to the image to be displayed and the display region, comprises:
obtaining a shape parameter of the display region and a shape parameter of the image to be displayed; and
obtaining the to-be-rectified region by using an image rectification algorithm based on the shape parameter of the display region and the shape parameter of the image to be displayed.

3. The image rectification method according to claim 1, wherein determining the to-be-rectified region of the image to be displayed according to the image to be displayed and the display region, comprises:
obtaining a shape parameter of the display region and a shape parameter of the image to be displayed;
determining an overlap region of the display region and the image to be displayed according to the shape parameter of the display region and the shape parameter of the image to be displayed; and
determining the to-be-rectified region of the image to be displayed according to a positional relationship of the overlap region, the image to be displayed, and the display region.

4. The image rectification method according to claim 3, wherein determining the to-be-rectified region of the image to be displayed according to the positional relationship of the overlap region, the image to be displayed, and the display region, comprises:
if the overlap region overlaps the image to be displayed, determining that a region corresponding to the image to be displayed is the to-be-rectified region;
if the overlap region overlaps the display region, determining a region of the image to be displayed that is outside the overlap region as the to-be-rectified region; or
if the overlap region is a part of both the display region and the image to be displayed, determining that a region corresponding to the image to be displayed is the to-be-rectified region.

5. The image rectification method according to claim 4, wherein rectifying the to-be-rectified region of the image to be displayed to make the rectified image to be displayed match the display region, comprises:
determining an image rectification algorithm according to the display region;
obtaining a source shape parameter and a target shape parameter of the to-be-rectified region; and
based on the source shape parameter and the target shape parameter, rectifying the to-be-rectified region by using the image rectification algorithm to make the rectified image to be displayed match the display region.

6. The image rectification method according to claim 1, wherein determining the to-be-rectified region of the image to be displayed comprises:
obtaining a trigger operation of a user; and
determining the to-be-rectified region according to the trigger operation.

7. An image rectification device, comprising:
a processor;
a memory configured to store instructions and files which are executable by the processor;
wherein the processor is configured to:
obtain an image to be displayed and a display region of a display screen;
determine a to-be-rectified region of the image to be displayed according to the image to be displayed and the display region; and
rectify the to-be-rectified region of the image to be displayed to make the rectified image to be displayed match the display region.

8. The image rectification device according to claim 7, wherein the processor is configured to:
obtain a shape parameter of the display region and a shape parameter of the image to be displayed; and
obtain the to-be-rectified region by using an image rectification algorithm based on the shape parameter of the display region and the shape parameter of the image to be displayed.

9. The image rectification device according to claim 7, wherein the processor is configured to:
obtain a shape parameter of the display region and a shape parameter of the image to be displayed;
determine an overlap region of the display region and the image to be displayed according to the shape parameter of the display region and the shape parameter of the image to be displayed; and
determine the to-be-rectified region of the image to be displayed according to a positional relationship of the overlap region, the image to be displayed, and the display region.

10. The image rectification device according to claim 9, wherein the processor is configured to:
if the overlap region overlaps the image to be displayed, determine that a region corresponding to the image to be displayed is the to-be-rectified region;
if the overlap region overlaps the display region, determine a region of the image to be displayed that is outside the overlap region as the to-be-rectified region; or
if the overlap region is a part of both the display region and the image to be displayed, determine that a region corresponding to the image to be displayed is the to-be-rectified region.

11. The image rectification device according to claim 10, wherein the processor is configured to:
determine an image rectification algorithm according to the display region;
obtain a source shape parameter and a target shape parameter of the to-be-rectified region; and
based on the source shape parameter and the target shape parameter, rectify the to-be-rectified region by using the image rectification algorithm to make the rectified image to be displayed match the display region.

12. The image rectification device according to claim 7, wherein the processor is configured to:
obtain a trigger operation of a user; and
determine the to-be-rectified region according to the trigger operation.

13. A non-transitory computer-readable storage medium having stored therein instructions that, when executed by a processor of a display device, causes the display device to perform image rectification method, the method comprising:
obtaining an image to be displayed and a display region of a display screen;
determining a to-be-rectified region of the image to be displayed according to the image to be displayed and the display region; and
rectifying the to-be-rectified region of the image to be displayed to make the rectified image to be displayed match the display region.
